(19) United States
(12) Patent Application Publication
(10) Pub. No.: US 2004/0132355 A1
(43) Pub. Date: Jul. 8, 2004

(54) Anchoring Device for a Jack Box in Service Boxes

(75) Inventor: Santiago Ferre Giro, Tarragon Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/707,335

(22) Filed: Dec. 5, 2003

(30) Foreign Application Priority Data
May 31, 2002 (ES) WO 02/097929

(51) Int. Cl. H01R 9/22

(52) U.S. Cl. 439/894

(57) ABSTRACT

Improved anchoring device for terminal boxes in service boxes, constituted of a slide closure mechanism articulated with a lid or cover of a connector.

### OBJECT OF THE INVENTION

The present invention, an improved anchoring device for terminal boxes in service boxes, consists of a novel and original structure or arrangement of the anchoring mechanism used in terminal boxes, especially proposed for specific applications in determined industrial sectors, particularly in electric assemblies in the automobile industry. As a result, the present invention will be of special interest for the manufacturing and supply sector of electric installation equipment, especially that which is dedicated to the auxiliary automobile industry.

### STATE OF THE ART

Currently, easily and quickly carrying out electric inter-connections is a requirement in the majority of auxiliary industries, where an assembly time reduction is required, which has promoted the development of new types of connectors. Said connectors are fundamentally based on the constitution of terminal boxes, fitted together, provided with closing and restraining flaps between both plug tap and socket parts of the connectors. Likewise, the connection is carried out by overcoming a determined pressure sure of said flaps, which cause both plug tap and socket parts to be coupled, the connection therefore being made.

Within this type of connectors are those in which the connections is formalized by means of a slide mechanism actuated on a cover or lid of the connector which is actuated in the closure mechanism thereof, said connection mechanism between the lid and slide having only one slide pivoting point, which occasionally causes one or both pivoting points to break due to the force exerted on the lid or cover. The present invention described below is related to an improvement developed for this type of connectors by means of a particular arrangement of the pivoting articulations related to said slide mechanism and which solves the mentioned drawback.

### DESCRIPTION OF THE INVENTION

The present invention, improved anchoring device for terminal boxes in service boxes, is constituted of a slide closure mechanism articulated with a lid or cover of a connector. Said slide consists of respective longitudinal guides running parallel and next to the sides of the connector body, being articulated to said lid or cover of the connector on one side thereof by means of double pivoting points, each one of said double points enveloping each one of the slide profiles on both lateral sides by means of a pivoting point, constituting an articulation of four pivoting points between slide and lid or cover of the connector. In this manner, said articulation between slide and lid or cover is reinforced, as it has four pivoting points rather than two.

Likewise, the outer wall of said slide of the connector is coincident with that of the outermost pivoting points, such that the wall of the slide prevents the outermost pivoting points from coming out.

### DESCRIPTION OF THE DRAWINGS

A detailed description of the improved anchoring device for terminal boxes in service boxes, object of the present invention, will be made below with reference to the accompanying drawings, in which a preferred embodiment form is shown as a non-limiting example, susceptible to all those variations in detail which imply no fundamental alteration of the essential features of said improvements.

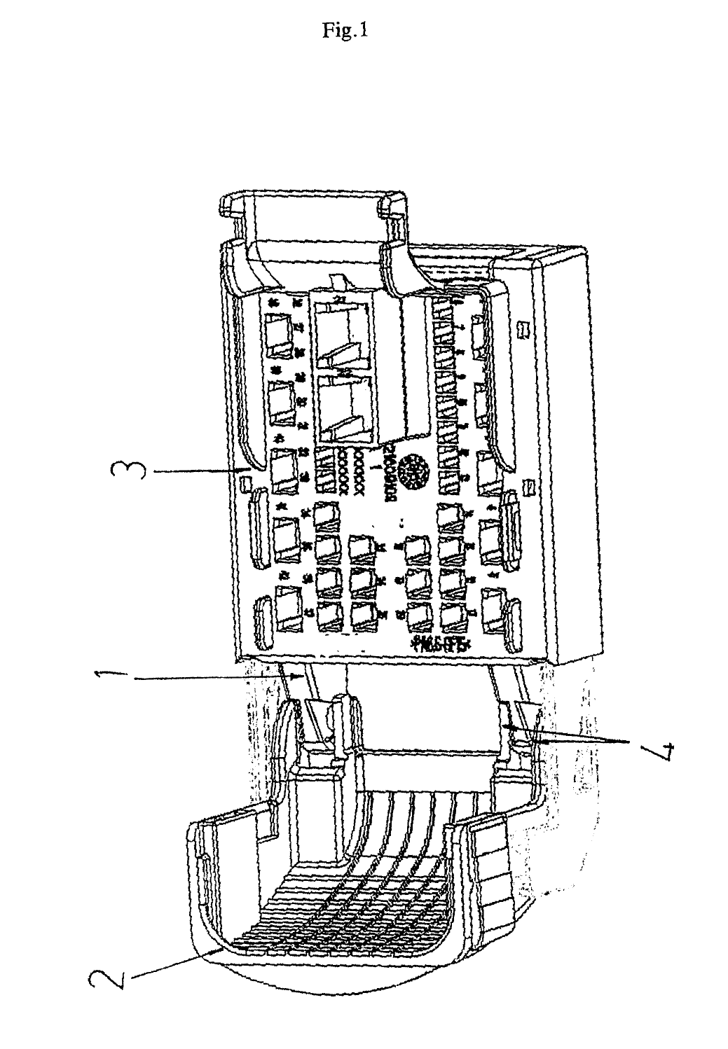

Said plans show: FIG. 1 shows a perspective view of the improved anchoring device for terminal boxes in service boxes.

### PREFERRED EMBODIMENT

The improved anchoring device for terminal boxes in service boxes shown in this preferred embodiment form is fundamentally constituted of a slide closure mechanism (1) articulated with a lid or cover (2) of a connector (3). Said slide consists of respective longitudinal guides running parallel and next to the sides of the body of the connector (3), being articulated to said lid or cover (2) of the connector on a side thereof by means of double pivoting points (4), each one of said double points enveloping each one of the profiles of the slide on both lateral sides by means of a pivoting point, constituting an articulation of four pivoting points between the slide (1) and lid or cover (2) of the connector. In this manner, said articulation between slide (1) and lid or cover (2) is reinforced, as it has four pivoting points rather than two.

Likewise, the outer wall of said slide (1) of the connector is coincident with that of the two outermost pivoting points (4), such that the wall of the slide (1) prevents the outermost pivoting points from coming out.

Finally, the shape, materials and dimensions can vary, and, generally, all that is accessory and secondary, as long as it does not alter, change or modify the essential improvements that have been disclosed.

1.- Improved anchoring device for terminal boxes in service boxes, constituted of a slide (1) closure mechanism articulated with a lid or cover (2) of a connector (3), characterized in that said slide consists of respective longitudinal guides running parallel and next to the sides of the body of the connector (3), being articulated to said lid or cover (2) of the connector on a side thereof by means of two double pivoting points (4), each one of said double points enveloping each one of the profiles of the slide on both lateral sides by means of a pivoting point, constituting an articulation of four pivoting points between the slide (1) and lid or cover (2) of the connector.

2.- Improved anchoring device for terminal boxes in service boxes according to claim 1, characterized in that the outer wall of said slide (1) of the connector is coincident with that of the outermost pivoting points (4).
